(19) United States
(12) Patent Application Publication
(10) Pub. No.: US 2016/0016842 A1
(43) Pub. Date: Jan. 21, 2016

(54) Glass Cutting Tool

(71) Applicant: Toyo Industrial Co., Ltd., Osaka (JP)

(72) Inventor: Asako Arai, Osaka (JP)

(21) Appl. No.: 14/800,937

(22) Filed: Jul. 16, 2015

(30) Foreign Application Priority Data
Jul. 16, 2014 (JP) 2014-146185

(51) Int. Cl. C03B 33/10

(52) U.S. Cl. CPC C03B 33/107

(57) ABSTRACT

A glass cutting tool having a wheel holder and a glass cutter wheel rotatably attached to the wheel holder via a pin, wherein the wheel holder has at least a part formed of a self-lubricating material having self-lubricity, the part potentially contacts with side surfaces of the glass cutter wheel.

### FIELD OF THE INVENTION

The present invention relates to a glass cutting tool for cutting glass used for a variety of electronic equipment. More specifically, the present invention relates to a glass cutting tool capable of reducing degradation of performance of the rotation of a glass cutter wheel and then increasing yields in scribe and break processes.

### BACKGROUND OF THE INVENTION

Thin glass with high breaking strength is used for electronic equipment such as flat panel displays, smart phones or tablet terminals having come into wide use recently. In cutting (scribing) such glass, glass cutter wheels as described in Patent Documents 1 to 3 are used, for example.

The invention described in Patent Document 1 (Japanese Published Unexamined Utility Model Application No. S55-127732) is such that a cemented carbide ring is fixed by brazing or the like to each surface of a wheel holder for sandwiching and holding a glass cutter wheel, thereby preventing wear of contact surfaces of the wheel holder with the glass cutter wheel and inhibiting an inclination of the glass cutter wheel and its axial movement.

The invention described in Patent Document 2 (Japanese Published Unexamined Patent Application No. 2011-240540) is such that a wheel holder has a lower portion formed with a space for arranging a glass cutter wheel and there are provided left and right support portions with the space therebetween. The left and right support portions are provided with cutter pin insertion holes arranged on a straight line such that mutual central axes are aligned. Ring bodies formed of a superhard material (sintered diamond or cemented carbide) and provided with a pin hole are attached by brazing to opening portions of the pin insertion holes and on inner surfaces facing each other of the support portions. With this, the perpendicularity of the cutter wheel is improved and the wear of rotation support parts is suppressed thereby to aim at maintaining the rotational accuracy.

The invention described in Patent Document 3 (Japanese Published Unexamined Patent Application No. 2014-065173) is provided with a glass cutter wheel having a through hole in the center thereof, a pair of wheel holders coupled so as to form a slit with parallel opposed surfaces and having respective through holes having the same central axis when coupled, a pair of spacers attached at positions of the mutually opposed through holes of the wheel holders, forming curved surfaces outwardly curved on outer circumferential surfaces, and having through holes in the centers, and a pin inserted into the through holes of the wheel holders and the pair of spacers and the through hole of the glass cutter wheel and rotatably holding the glass cutter wheel. With this, a contact area between side surfaces of the glass cutter wheel and the spacers or shaft support portions is made smaller, so that the friction can be reduced and then the linearity of the scribe line can be improved. Furthermore, the wear between the side surfaces of the glass cutter wheel and the spacers or shaft support portions can be reduced, and accordingly, the glass cutter wheel can have a longer service life.

### SUMMARY OF THE INVENTION

The prior glass cutting tools as above have the following problems. That is, there is a problem that the friction caused by contacting with the members intervening between the wheel holder and the glass cutter wheel cannot be reduced when the glass cutter wheel is rotated, and then, the performance of the rotation of the glass cutter wheel is degraded. This leads to a problem that chipping may occur in a scribe line produced when the glass is cut (scribed), and a glass cracking failure may occur in the subsequent glass dividing (break) process.

Accordingly, in view of the foregoing problems, the present invention aims at providing a glass cutting tool capable of reducing degradation of performance of the rotation of the glass cutter wheel and then increasing yields in the scribe and break processes.

The foregoing object of the present invention is achieved by the following means. It is noted that numerals in parentheses are reference numerals of embodiments described later but the present invention should not be limited thereto.

According to the invention, a glass cutting tool is characterized by a wheel holder (2) and a glass cutter wheel (3) rotatably attached to the wheel holder (2) via a mounting shaft (a pin 4), wherein the wheel holder (2) has at least a part formed of a material (a self-lubricating member 22d) having self-lubricity, the part potentially contacts with side surfaces of the glass cutter wheel (3).

According to the invention, a glass cutting tool is characterized by a wheel holder (2A), a glass cutter wheel (3) rotatably attached to the wheel holder (2A) via a mounting shaft (a pin 4), and a self-lubricating member (5) having self-lubricity, the self-lubricating member (5) is provided between side surfaces of the glass cutter wheel (3) and the wheel holder (2).

Subsequently, effects of the present invention will be described by giving reference numerals of the drawings. It is noted that numerals in parentheses are reference numerals of the embodiments described later but the present invention should not be limited thereto.

According to the invention, even if the glass cutter wheel (3) comes in contact with the wheel holder (2), the potentially contacting part of the wheel holder (2) is formed of the material (the self-lubricating member 22d) having self-lubricity. Therefore, the coefficient of friction of the contact surface between the glass cutter wheel (3) and the wheel holder (2) is reduced by the material (the self-lubricating member 22d), and then the degradation of performance of the rotation of the glass cutter wheel (3) can be reduced. As a result, the scribe line produced when the glass is cut (scribed) can be made uniform, and then occurrence of chipping can be reduced. Further, good glass dividing can be performed also in the subsequent glass bend-braking (break) process.

Thus, according to the present invention, the degradation of performance of the rotation of the glass cutter wheel can be reduced, and then yields in the scribe and break processes can be increased.

According to the invention, even if the glass cutter wheel (3) comes in contact with the wheel holder (2), the self-lubricating member (5) having self-lubricity is provided between the potentially contacting side surfaces of the glass cutter wheel (3) and the wheel holder (2). Therefore, the coefficient of friction of the contact surface between the glass cutter wheel (3) and the wheel holder (2) is reduced by the self-lubricating member (5), and the degradation of performance of the rotation of the glass cutter wheel (3) can be reduced. As a result, the scribe line produced when the glass is cut (scribed) can be made uniform, and then occurrence of chipping can be reduced. Further, good glass dividing can be performed also in the subsequent glass bend-breaking (break) process.

Thus, according to the present invention as well, the degradation of performance of the rotation of the glass cutter wheel can be reduced, and then yields in the scribe and break processes can be increased.

### BRIEF DESCRIPTION OF THE DRAWINGS

FIGS. 1A and 1B show a glass cutting tool according to the first embodiment of the present invention, wherein FIG. 1A is a side view and FIG. 1B is a front view.

FIG. 2 is an enlarged view of a part A shown in FIG. 1B.

FIG. 3A is a diagram showing a glass cutting tool according to the second embodiment of the present invention.

FIG. 3B is a diagram showing a cross-section of a self-lubricating member of the glass cutting tool of FIG. 3A.

FIG. 4 is a diagram showing how the value of the coefficient of friction of a superhard material and the value of that of gunmetal are changed by the number of times the superhard material and the gunmetal are respectively slid on superhard plates.

### DETAILED DESCRIPTION OF THE INVENTION

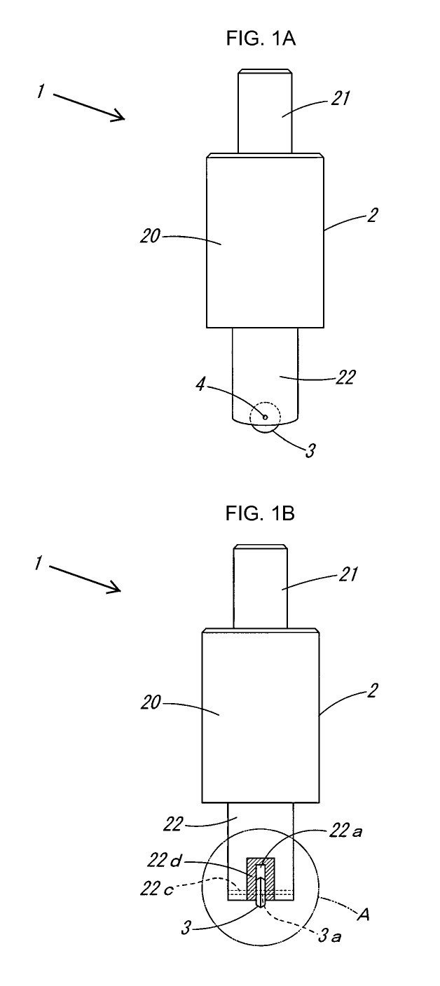

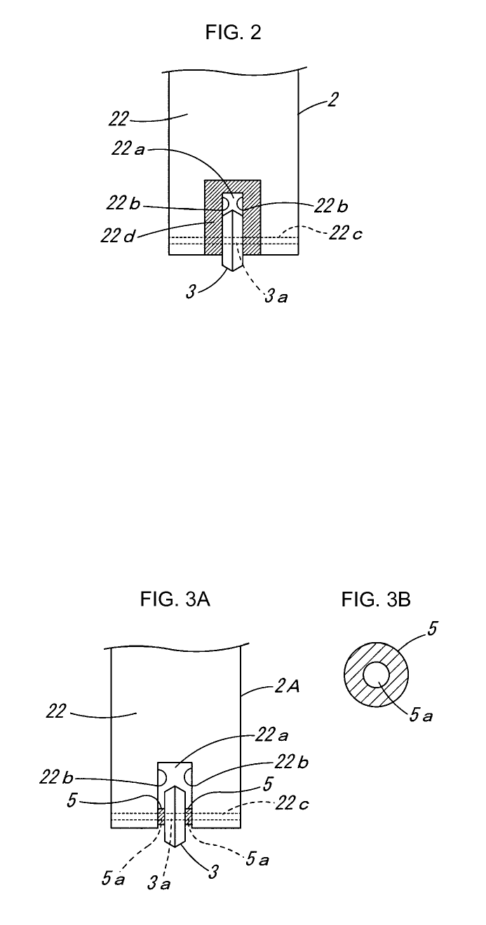

Hereinafter, the first embodiment of a glass cutting tool according to the present invention will be described in detail with reference to FIG. 1 and FIG. 2.

As shown in FIG. 1, a glass cutting tool 1 is composed of a wheel holder 2 and a glass cutter wheel 3. The wheel holder 2 is formed mainly of a material such as hardened steel, and a part thereof contacting with both side surfaces of the glass cutter wheel 3 is formed of a material such as gunmetal having self-lubricity, metal sintered material which is called an oil-less metal or copper-base or iron-base sintered material.

The wheel holder 2 formed of such material is composed of a wheel holder central portion 20 formed in a substantially cylindrical shape, a substantially cylindrical wheel holder upper portion 21 protruded from an upper end portion of the wheel holder central portion 20 and having a diameter smaller than that of the wheel holder central portion 20, and a substantially cylindrical wheel holder lower portion 22 protruded from a lower end portion of the wheel holder central portion 20 and having a diameter smaller than that of the wheel holder central portion 20, as shown in FIG. 1.

The wheel holder lower portion 22 has a lower end portion formed with a groove portion 22a capable of storing the glass cutter wheel 3 and having a U shape in a front view as shown in FIG. 1B and FIG. 2. In addition, a circular pin insertion hole 22c penetrates both side wall surfaces 22b (see FIG. 2) formed on the groove portion 22a and arranged facing each other, in a direction perpendicular to the both side wall surfaces 22b toward the groove portion 22a side as shown in FIG. 2. To the thus penetrating pin insertion hole 22c, a pin 4 is inserted as shown in FIG. 1A. To the inserted pin 4, the foregoing glass cutter wheel 3 is rotatably attached as shown in FIG. 1B and FIG. 2. By this, the glass cutter wheel 3 is rotatably stored within the groove portion 22a, and resultingly, the glass cutter wheel 3 is rotatably attached to the wheel holder 2. In inserting the pin 4 into the pin insertion hole 22c, the pin 4 is press-fittingly inserted and crimped.

Further, the wheel holder lower portion 22 is integrally provided with a self-lubricating member 22d having self-lubricity so as to be along an outer peripheral wall surface of the groove portion 22a. This self-lubricating member 22d is formed of a material such as gunmetal, metal sintered material which is called an oil-less metal or copper-base or iron-base sintered material. In the present embodiment, the example is shown in which the self-lubricating member 22d having self-lubricity is integrally provided to the outer peripheral wall surface of the groove portion 22a. However, without being limited thereto, the self-lubricating member 22d may be composed of a separate member and provided to the outer peripheral wall surface of the groove portion 22a by affixation, coating or brazing or the like. Further, the wheel holder 2 may be formed only of a material such as gunmetal having self-lubricity, metal sintered material which is called an oil-less metal or copper-base or iron-base sintered material.

On the other hand, the glassy cutter wheel 3 is formed of a material such as cemented carbide or diamond single crystal and formed in a disc shape as shown in FIG. 1A. The glass cutter wheel 3 has a central portion formed with a through hole 3a. The glass cutter wheel 3 has a V-shaped blade forming a ridge along an outer circumferential portion. In rotatably storing the thus configured glass cutter wheel 3 within the groove portion 22a of the wheel holder 2, the pin insertion hole 22c of the wheel holder 2 and the through hole 3a of the glass cutter wheel 3 are arranged so as to be coaxial. In this state, the pin 4 is inserted, thereby allowing the glass cutter wheel 3 to be rotatably stored within the groove portion 22a of the wheel holder 2.

The thus configured glass cutting tool 1 is attached to a glass cutting device (not shown), and the glass is cut (scribed) by the glass cutter wheel 3 having the V-shaped blade forming a ridge along the outer circumferential portion.

Even if the glass cutter wheel 3 comes in contact with the wheel holder 2 at this time, the self-lubricating member 22d having self-lubricity is provided to the potentially contacting outer peripheral wall surface of the groove portion 22a of the wheel holder 2. Therefore, the coefficient of friction of the contact surface between the glass cutter wheel 3 and the wheel holder 2 is reduced by this self-lubricating member 22d, and the degradation of performance of the rotation of the glass cutter wheel 3 can be reduced. As a result, the scribe line produced when the glass is cut (scribed) can be made uniform, and then occurrence of chipping can be reduced. Further, good glass dividing can be performed also in the subsequent glass bend-breaking (break) process.

According to the present embodiment, the degradation of performance of the rotation of the glass cutter wheel can be reduced, and then yields in the scribe and break processes can be increased.

In the present embodiment, the example is shown in which the glass cutting tool 1 is attached to the glass cutting device (not shown). However, without being limited thereto, the present invention may be applied to hand glass cutting.

### Examples

Next, the present embodiment will be described in more detail with the use of Examples and Comparative Examples.

As for Example 1, as the wheel holder 2 of the glass cutting tool 1, a material of gunmetal was used for the self-lubricating member 22d of the wheel holder 2. As for Comparative Example 1, the one provided with no self-lubricating member 22d and using a superhard material was used as the wheel holder 2 of the glass cutting tool 1.

As the glass cutter wheel 3, the one having an outer diameter of 2.5 mm, an inner diameter of 0.8 mm, a thickness of 0.65 mm, a cutting edge angle of 120° was used for both Example 1 and Comparative Example 1.

As the glass, the one formed of a hard-type material and having a thickness of 0.7 mm and a size of 360 mm×460 mm was used.

The glass cutting tool 1 as above was attached to a glass cutting device which was a test-only machine manufactured by Toyo Industrial Co., Ltd. The scribe weight was set at 0.04 MPa, the scribe speed at 300 mm/sec, and the depth of cut by the glass cutter wheel 3 with respect to a surface of the glass at 0.05 mm. The longitudinal direction of the glass (460 mm) was cut (scribed) at 5 mm intervals. The amount of chipping that occurred from scribe lines was visually counted by a microscope manufactured by KEYENCE CORPORATION. The results thereof are shown in Table 1.

TABLE 1

| | The number of scribe lines | | | | |
|---|---|---|---|---|---|
| | 1 to | 1501 to | 2001 to | 2501 to | 3001 to |
| | 1500 | 2000 | 2500 | 3000 | 3500 |
| Example 1 | 5 | 11 | 18 | 18 | 20 |
| Comparative | 2 | 4 | 24 | 49 | 62 |
| Example 1 | | | | | |

The Table 1 shows how much chipping occurred with respect to the number of scribe lines. It was found that, when the wheel holder 2 using a material of gunmetal for the self-lubricating member 22d (Example 1) was used, the amount of chipping was smaller even if the number of scribe lines was increased.

Next, five pieces of the glass cutter wheels 3 were prepared. The glass was cut (scribed) at 5 mm intervals by using each of the glass cutter wheels 3 under the same conditions as the above. The results thereof are shown in Table 2 and Table 3. Table 2 represents the glass cutter wheels where the wheel holders 2 using a superhard material were used. Table 3 represents the glass cutter wheels where the wheel holders 2 using a material of gunmetal for the self-lubricating member 22d were used.

TABLE 2

| Glass | The number of scribe lines | | | | |
|---|---|---|---|---|---|
| cutter | 1 to | 1501 to | 2001 to | 2501 to | 3001 to |
| wheel | 1500 | 2000 | 2500 | 3000 | 3500 |
| 1 | 2 | 4 | 24 | 49 | 62 |
| 2 | 0 | 3 | 29 | 32 | 53 |
| 3 | 3 | 5 | 30 | 49 | 57 |
| 4 | 2 | 8 | 45 | 54 | 72 |
| 5 | 1 | 4 | 41 | 73 | 85 |

TABLE 3

| Glass | The number of scribe lines | | | | |
|---|---|---|---|---|---|
| cutter | 1 to | 1501 to | 2001 to | 2501 to | 3001 to |
| wheel | 1500 | 2000 | 2500 | 3000 | 3500 |
| 1 | 5 | 11 | 18 | 18 | 20 |
| 2 | 3 | 4 | 4 | 8 | 12 |
| 3 | 6 | 9 | 9 | 12 | 16 |
| 4 | 2 | 5 | 6 | 7 | 14 |
| 5 | 3 | 3 | 5 | 9 | 20 |

As shown in Table 2, it was found that, when the wheel holders 2 using a superhard material were used, the amount of chipping was increased as the number of scribe lines was increased and varied widely among the glass cutter wheels 3.

On the other hand, when the wheel holders 2 using a material of gunmetal for the self-lubricating member 22d were used, as shown in FIG. 3, it was found that, the amount of chipping was not increased much even if the number of scribe lines was increased and did not vary widely among the glass cutter wheels 3.

If the glass cutter wheel causes improper rotation during the cutting (scribing) of the glass, the scribe line is discontinued and becomes dotted, and a crack (vertical crack) growing in the vertical direction from the surface of the glass is not produced thereat but a crack (horizontal crack) horizontally growing on the surface of the glass from the scribe line is produced, and results in chipping therefrom, in general. The cause of bringing about such a state is considered to be abrasion of the cutting edge of the glass cutter wheel. However, in view of the above results, it can be confirmed that the occurrence of chipping varies widely depending on the material of the wheel holder.

Accordingly, in view of the above results, it was found that the degradation of performance of the rotation of the glass cutter wheel 3 can be reduced by providing the self-lubricating member 22d having self-lubricity to the outer peripheral wall surface of the groove portion 22a of the wheel holder 2, whereby the scribe line produced when the glass is cut (scribed) can be made uniform and the occurrence of chipping can be reduced.

<Frictional Resistance Test>

Meanwhile, a reason why the degradation of performance of the rotation of the glass cutter wheel 3 is reduced is considered to be that the coefficient of friction of the contact surface between the glass cutter wheel 3 and the wheel holder 2 is reduced. To verify this point, a test was carried out according to the following procedure.

<Test Procedure>

Tester: TriboGear 14FW manufactured by Shinto Scientific Co., Ltd.

Room temperature: 25° C.

Humidity: 50%

Load at the time of testing: 100 g

Measuring speed: 25 mm/sec

Sliding distance: A total of 120 mm per stroke (one way: 60 mm)

Contents of test: A sectional surface of a 3 φ superhard material and a sectional surface of a 3 φ copper-based sintered metal having self-lubricity, that is, gunmetal, were made to slide 3500 times (counting one stroke as one time) on respective superhard plates having a length of 100 mm, and changes over time in the coefficient of friction were compared.

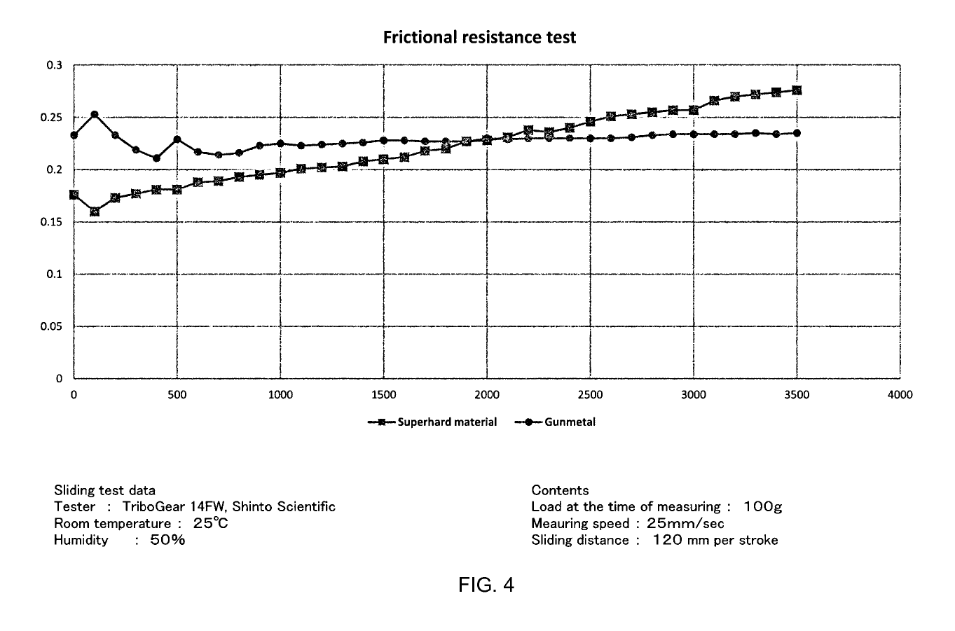

A line graph shown in FIG. 4 shows the results of this test. According to the test results, it was found that the superhard material had a lower coefficient of friction and the gunmetal exhibited high values at an early stage of sliding. However, it was found that the value of the coefficient of friction of the gunmetal was substantially constant from around the time when the number of times of sliding exceeds 500 and up to 3500, which was the time when the test was completed.

On the other hand, it was found that the coefficient of friction of the superhard material exhibited low values of 0.2 or less at an early stage of sliding, but thereafter, the value regularly increased and exceeded the value of the coefficient of friction of the gunmetal at around the 2000th time of sliding, and after that, the difference with the value of the coefficient of friction of the gunmetal tended to expand gradually.

From the foregoing results, it was found that the gunmetal having self-lubricity had a stable coefficient of friction even after a long time of use, whereas the superhard material had an increasing coefficient of friction with a longer time of use.

From this, when the gunmetal having self-lubricity was used for the contact surface between the glass cutter wheel 3 and the wheel holder 2, the coefficient of friction was stable, thus, it was verified that the glass cutter wheel 3 rotates stably.

On the other hand, when the superhard material was used for the contact surface between the glass cutter wheel 3 and the wheel holder 2 as in the conventional art, the coefficient of friction increased, thus, it was verified that the rotation of the glass cutter wheel 3 was difficult to stabilize.

A reason why the superhard material has a lower coefficient of friction and the gunmetal exhibits high values at an early stage of sliding is as follows. When the superhard material and the gunmetal are sliced (cut) into rounds, sectional surfaces (cut surfaces) thereof do not become dead flat and microscopic asperities are formed thereon. Since the gunmetal is a soft material as compared to the superhard material, the sectional surface (cut surface) is not easily made dead flat and a great number of microscopic asperities are formed on the sectional surface (cut surface) of the gunmetal as compared to the number of microscopic asperities formed on the sectional surface (cut surface) of the superhard material. Accordingly, it is conceivable that the superhard material has a coefficient of friction lower than that of the gunmetal at an early stage of sliding due to the number of microscopic asperities. However, as the sectional surface is made to slide on the superhard plate, the asperities are removed to be flat. As a result, the coefficient of friction exhibits stable behavior. That is, the value of the coefficient of friction of the gunmetal does not show extreme ups and downs and becomes stable (values are substantially constant) from around when the number of times of sliding exceeds 500. The value of the coefficient of friction of the superhard material does not show extreme ups and downs and becomes stable (values regularly increase) from around when the number of times of sliding exceeds 200. Consequently, the superhard material has a lower coefficient of friction and the gunmetal exhibits high values at an early stage of sliding.

Next, the second embodiment of the glass cutting tool according to the present invention will be described in detail with reference to FIGS. 3A and 3B. The same configurations as those of the first embodiment are given the same numerals and their descriptions are omitted.

In the first embodiment, the example has been shown in which the self-lubricating member 22d having self-lubricity is integrally provided to the outer peripheral wall surface of the groove portion 22a formed in the wheel holder lower portion 22. At that time, the point that the self-lubricating member 22d may be composed of a separate member has been described. The second embodiment represents this specific example in which the self-lubricating member 22d may be composed of a separate member. The difference between the first and second embodiments is only a part related to the wheel holder. Therefore, that point will be described in detail.

A wheel holder 2A shown in FIG. 3A is formed of a material such as hardened steel, and a material having self-lubricity is not used. The wheel holder 2A formed of such material has a wheel holder lower portion 22 formed with a groove portion 22a, within which a glass cutter wheel 3 is rotatably stored. A pair of self-lubricating members 5 are arranged between both side surfaces of the glass cutter wheel 3 and both side wall surfaces 22b of the groove portion 22a.

The self-lubricating members 5 are formed of a material such as gunmetal, metal sintered material which is called an oil-less metal or copper-base or iron-base sintered material. As shown in FIG. 3B, the self-lubricating members 5 are formed in a disc shape and provided with a circular through hole 5a in the center. In arranging the thus formed self-lubricating members 5 between the both side surfaces of the glass cutter wheel 3 and the both side wall surfaces 22b of the groove portion 22a, the pin insertion hole 22c of the wheel holder 2, the through hole 3a of the glass cutter wheel 3, and the through holes 5a of the pair of self-lubricating members 5 are arranged so as to be coaxial. In this state, the pin 4 may be inserted. By doing so, the pair of self-lubricating members 5 can be arranged between the both side surfaces of the glass cutter wheel 3 and the both side wall surfaces 22b of the groove portion 22a.

In this embodiment as well, the pair of self-lubricating members 5 are arranged at places where the glass cutter wheel 3 potentially contact with the wheel holder 2 when the glass is cut (scribed), that is, between the both side surfaces of the glass cutter wheel 3 and the both side wall surfaces 22b of the groove 22a in the wheel holder 2. Therefore, the coefficient of friction of the contact surface between the glass cutter wheel 3 and the wheel holder 2 is reduced by the self-lubricating members 5, and then the degradation of performance of the rotation of the glass cutter wheel 3 can be reduced. As a result, the scribe line produced when the glass is cut (scribed) can be made uniform, and then the occurrence of chipping can be reduced. Further, good glass dividing can be performed also in the subsequent glass bend-breaking (break) process.

In this embodiment as well, the degradation of performance of the rotation of the glass cutter wheel can be reduced, and then yields in the scribe and break processes can be increased. It is a matter of course that the glass cutting tool in this embodiment can be applied to either the glass cutting device or hand glass cutting.

What is claimed is:

1. A glass cutting tool comprising:
a wheel holder; and
a glass cutter wheel rotatably attached to the wheel holder via a mounting shaft,
wherein the wheel holder has at least a part formed of a material having self-lubricity, the part potentially contacts with side surfaces of the glass cutter wheel.

2. A glass cutting tool comprising:
a wheel holder;
a glass cutter wheel rotatably attached to the wheel holder via a mounting shaft; and
a self-lubricating member having self-lubricity, the self-lubricating member is provided between side surfaces of the glass cutter wheel and the wheel holder.
